(19) United States
(12) Patent Application Publication
(10) Pub. No.: US 2009/0025050 A1
(43) Pub. Date: Jan. 22, 2009

(54) Terminal apparatus used in information distribution system, recording medium on which information processing program is recorded, and information processing method

(75) Inventor: Shinichi Takatsuka, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya-Shi (JP)

(21) Appl. No.: 12/216,983

(22) Filed: Jul. 14, 2008

(30) Foreign Application Priority Data
Jul. 17, 2007 (JP) 2007-186084

(51) Int. Cl. H04N 7/173

(52) U.S. Cl. 725/98

(57) ABSTRACT

To provide a terminal apparatus, an information processing program, and an information processing method, with which a noise reduction and power saving are possible. A terminal apparatus puts an HDD into a stopped condition when a main switch is in a deactivated condition and, receiving a distribution request, temporarily puts the HDD into a driven condition when contents information which is a subject of the distribution request is stored in the HDD, and distributes the contents information. When the distribution of the contents information is completed, the terminal apparatus puts the HDD into the stopped condition. By this means, holding a time of the driven condition of the HDD to a minimum, a noise reduction and power saving are realized.

### CROSS-REFERENCE TO RELATED APPLICATION(S)

This application is based on and claims the benefit of priority from Japanese Patent Application No. 2007-186084 filed on Jul. 17, 2007; the entire contents of which are incorporated herein by reference.

### BACKGROUND OF THE INVENTION

1. Field of the Invention

The present invention relates to a terminal apparatus used in an information distribution system, a recording medium on which an information processing program is recorded, and an information processing method, and relates in particular to a terminal apparatus used in an information distribution system which, being formed by a participation of a plurality of terminal apparatus mutually connected via a network, carries out a transmission and reception of contents information among the terminal apparatus, a recording medium on which an information processing program is recorded, and an information processing method.

2. Description of the Related Art

In recent years, along with a spread of a broadband, an information distribution service which distributes contents information such as music data and movie data has become popular. For example, a service which distributes contents information in response to a request from a user, as with a VOD (Video On Demand), has been known.

With this kind of information distribution service, a distribution format according to a server client method has been mainstream, but recently, a P2P (Peer to Peer) type distribution format, which transmits and receives contents information among terminal apparatus, is attracting attention as a new distribution format replacing this method.

The P2P type information distribution system, being a system formed by a participation of a plurality of terminal apparatus (node apparatus) mutually connected via a network, transmits and receives contents information, saved dispersed among the plurality of terminal apparatus, among the terminal apparatus. That is, it acquires contents information which a user of a certain terminal apparatus is attempting to acquire from another terminal apparatus which holds one portion of, or all of, the contents.

For example, with an information distribution system described in Japanese Unexamined Patent Publication No. 2006-197400, it not being the case that each terminal apparatus is aware of location information (an IP address or the like) of all terminal apparatus participating in the information distribution system, it holds only location information of one portion of the terminal apparatus acquired at a time of participating or the like. Then, in accordance with a user's request to view or listen, based on such location information, it carries out a search for contents information, and carries out a transmission and reception of the contents information among the terminal apparatus.

### SUMMARY OF THE INVENTION

With this kind of information distribution system, in a case of not viewing or listening to contents information, the user deactivates a main switch, stopping a power supply and putting a whole of a terminal apparatus into a stopped condition. However, when the terminal apparatus has stopped viewing and listening and attains the stopped condition, it withdraws from the information distribution system, and is unable to carry out a distribution of contents information. For this reason, there has been a problem in that an efficiency of distributing contents information as the information distribution system decreases, and a burden on a contents server which supplies contents information increases.

In order to solve this kind of problem, it is envisaged to configure in such a way as to carry out a distribution of contents information, even with a terminal apparatus which has stopped viewing and listening. That is, in the case of not viewing or listening to contents information, even though the user deactivates the main switch, it is sufficient, maintaining the power supply to the terminal apparatus and keeping it in a started up condition, to wait for a distribution request transmitted from another terminal apparatus.

However, in the case in which the terminal apparatus is kept in the started up condition when it has stopped viewing and listening, despite it not viewing or listening to contents information, there has been a problem in that noise accompanying a revolution of or access to an HDD (Hard Disc Drive) which stores contents information occurs, and also wasteful energy is consumed.

Consequently, in an information distribution system which, being formed by a participation of a plurality of terminal apparatus mutually connected via a network, carries out a transmission and reception of contents information among the terminal apparatus, it is desirable to provide a terminal apparatus, a recording medium on which is recorded an information processing program, and an information processing method, with which a noise reduction and power saving in the terminal apparatus are possible.

According to an embodiment of the present invention, there is provided a terminal apparatus in an information distribution system which, being formed by a participation of a plurality of terminal apparatus mutually connected via a network, carries out a transmission and reception of contents information among the terminal apparatus, the terminal apparatus including a contents information storage section which stores the contents information, a contents list storage section which stores a list of the contents information stored in the contents information storage section, and a controller which controls the contents information storage section and the contents list storage section. The controller includes a stop control section which puts the contents information storage section into a stopped condition, a contents existence determination section which, in a case of receiving a request for a distribution of contents information from another terminal apparatus, by means of a contents list stored in the contents list storage section, determines whether or not the contents information which is the subject of the distribution request is stored in the contents information storage section, a drive control section which, in a case in which it is determined, by the contents existence determination section, that the contents information which is the subject of the distribution request is stored in the contents information storage section, puts the contents information storage section into a driven condition, and a contents distribution section which, after the contents information storage section has attained the driven condition due to the drive control section, retrieves the contents information which is the subject of the distribution request from the contents information storage section, and distributes it.

### BRIEF DESCRIPTION OF THE DRAWINGS

FIG. 1 is a diagram showing one example of a connection aspect of each terminal apparatus in an information distribution system according to an embodiment of the invention;

FIG. 2 is an illustration of an ID space;

FIG. 3A is an illustration of a routing table;

FIG. 3B is an illustration of the routing table;

FIG. 4 is one example of the routing table;

FIG. 5 is a diagram showing an aspect of a contents holding terminal apparatus registration message being forwarded by DHT routing;

FIG. 6 is one example of an index table;

FIG. 7 is a diagram showing one example of an operation when a request terminal apparatus acquires contents information;

FIG. 8 is an outline diagram showing a functional configuration example of the terminal apparatus;

FIG. 9A is a diagram showing a first process flow;

FIG. 9B is a diagram showing a continuation of the first process flow;

FIG. 10A is a diagram showing a second process flow;

FIG. 10B is a diagram showing a continuation of the second process flow;

FIG. 10C is a diagram showing a continuation of the second process flow;

FIG. 11A is a diagram showing a third process flow;

FIG. 11B is a diagram showing a continuation of the third process flow; and

FIG. 12 is a diagram showing a fourth process flow.

### DESCRIPTION OF THE PREFERRED EMBODIMENT(S)

Hereafter, a specific description will be given, referring to the drawings, of an embodiment of the invention. An information distribution system according to the embodiment of the invention, being formed by a participation of a plurality of terminal apparatus mutually connected via a network, carries out a transmission and reception of contents information among the terminal apparatus. Hereafter, a description will be given of the information distribution system, after which, a description will be given of a method of realizing noise reduction and power saving in the terminal apparatus.

1. Configuration etc. of Information Distribution System

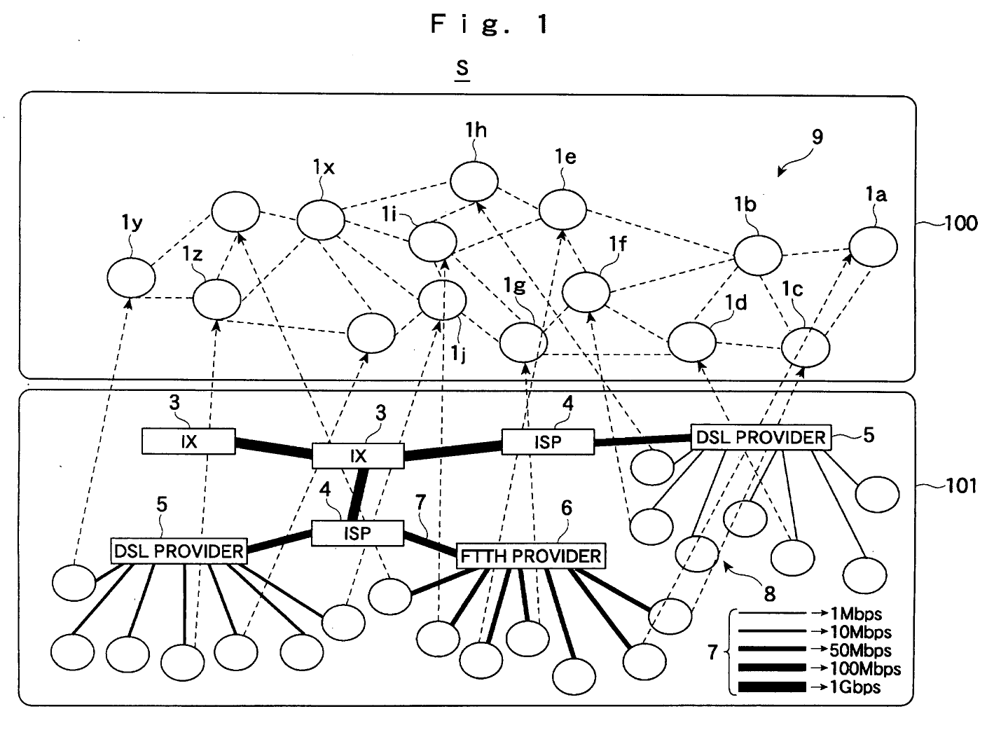

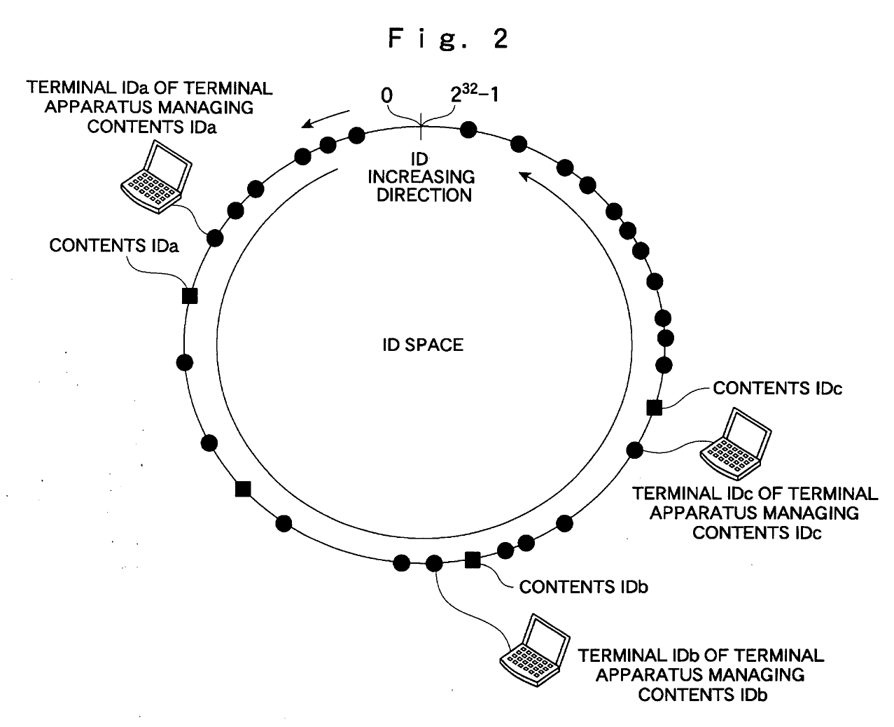

Firstly, a description will be given, referring to FIGS. 1 and 2, of an outline of the information distribution system according to the embodiment of the invention. FIG. 1 is a diagram showing one example of a connection aspect of each terminal apparatus in the information distribution system S, while FIG. 2 is an illustration of an ID space.

As shown within a lower frame 101 of FIG. 1, a network (a network in the actual world) 8, such as an internet, is constructed of an IX (Internet eXchange) 3, an ISP (Internet Service Provider) 4, a DSL (Digital Subscriber Line) provider (a device thereof) 5, an FTTH (Fiber To The Home) provider (a device thereof) 6, a communication line (for example, a telephone line, an optical cable, or the like) 7 and the like.

As shown within an upper frame 100 of FIG. 1, the information distribution system S, being configured including a plurality of terminal apparatus 1a, 1b, 1c . . . 1x, 1y, 1z . . . mutually connected via the network 8, is a peer-to-peer (P2P) type of network system. A unique manufacturing number (for example, a MAC address) and IP (Internet Protocol) address are allotted, as information indicating a terminal apparatus, to each terminal apparatus 1a, 1b, 1c . . . 1x, 1y, 1z . . . . The manufacturing number and IP address are not duplicated among the plurality of terminal apparatus. Also, in the following description, in a case of indicating any one terminal apparatus among the terminal apparatus 1a, 1b, 1c . . . 1x, 1y, 1z . . . or all of the terminal apparatus, it or they may be referred to as the terminal apparatus 1, for the sake of convenience.

In the information distribution system S, a kind of overlay network 9 shown within the upper frame 100 of FIG. 1 is constructed by an algorithm using a distributed hash table (hereafter, called a “DHT”). That is, the overlay network 9 refers to a network configuring a virtual link formed using the already existing network 8, and the terminal apparatus 1 disposed in the overlay network 9 are called terminal apparatus participating in the information distribution system S (in other words, participating in the overlay network 9).

A unique number is given to each terminal apparatus 1 as a terminal ID, which is an identification number of each terminal apparatus 1 participating in the information distribution system S. In the embodiment, a unique value of the IP address, or manufacturing number or the like, of each terminal apparatus 1 is hashed with a common hash function (a hash algorithm), and a hash value obtained by this means is taken to be the terminal ID of each terminal apparatus 1. In this way, as long as the IP address or manufacturing number differ, the terminal ID obtained by hashing with a common hash function are extremely unlikely to have the same value. As the hash function is public knowledge, a detailed description will be omitted. Also, in the following description, a value of the IP address (a global IP address) hashed with the common hash function will be taken as the terminal ID.

Also, in the plurality of terminal apparatus 1 participating in the information distribution system S, although contents information (for example, as music data, movie data, document data or the like), as common information distributed from one terminal apparatus 1 to other terminal apparatus 1, is stored distributed, an identification number (hereafter called a “contents ID”), unique to each item of contents information, is given to the contents information too. Then, the contents ID is made the same length as the terminal ID (for example, 32 bits), and a contents information name (for example, a data file name) or the like is hashed with the common hash function used when acquiring the terminal ID, and is disposed in the same ID space as the hash value of the terminal apparatus 1 IP address.

In this way, as the terminal ID and contents ID, given respectively to each terminal apparatus 1 and each item of contents information, are generated by the common hash function, it is possible to think of them existing scattered, with no particular bias, in one ring-shaped ID space, as shown in FIG. 2. The figure illustrates the terminal ID and contents ID given at 32 bits. In the figure, round marks indicate the terminal ID, and squares the contents ID, and the ID increase in a counter-clockwise direction.

In the embodiment, a rule being applied to the effect that “a terminal apparatus managing contents information which has a certain contents ID is a terminal apparatus which has a terminal ID near the contents ID”, a definition of “near” is that, without exceeding the contents ID, a difference between the contents ID and the terminal ID is the smallest, although in practice another definition is also acceptable, as long as it is consistent when allotting a management of each item of contents information to the terminal apparatus 1. In the example shown in FIG. 2, based on the definition, a contents IDa is managed by a terminal apparatus 1 having a terminal ID near the contents IDa (hereafter called a “terminal IDa”), a contents IDb is managed by a terminal apparatus 1 having a terminal ID near the contents IDb (hereafter called a “terminal IDb”), and a contents IDc is managed by a terminal apparatus 1 having a terminal ID near the contents IDc (hereafter called a “terminal IDc”).

Herein, “managed” means, not that the terminal apparatus 1 is holding the contents information, but that “it knows which terminal apparatus 1 the contents information is being held in”. That is, it means that the terminal apparatus 1 holds location information (herein, taken to be an IP address) of a terminal apparatus 1 (hereafter called a “contents holding terminal apparatus”) holding contents information transmitted and received within the information distribution system S. For example, in FIG. 2, the terminal apparatus 1 which has the terminal IDa knows in which of the terminal apparatus 1 the contents information having the contents data IDa is being held, and the terminal apparatus 1 which has the terminal IDb, and the terminal apparatus 1 which has the terminal IDc, also know, in the same way, in which of the terminal apparatus 1 the contents information having the contents data IDb, and the contents information having the contents data IDc, respectively are being held.

In this way, the terminal apparatus 1 which knows in which of the terminal apparatus 1 certain contents information is being held is called a root terminal apparatus of that contents information. That is, the terminal apparatus 1 which has the terminal IDa is the root terminal apparatus of the contents information having the contents IDa, the terminal apparatus 1 which has the terminal IDb is the root terminal apparatus of the contents information having the contents IDb, and the terminal apparatus 1 which has the terminal IDc is the root terminal apparatus of the contents information having the contents IDc.

2. Routing Table

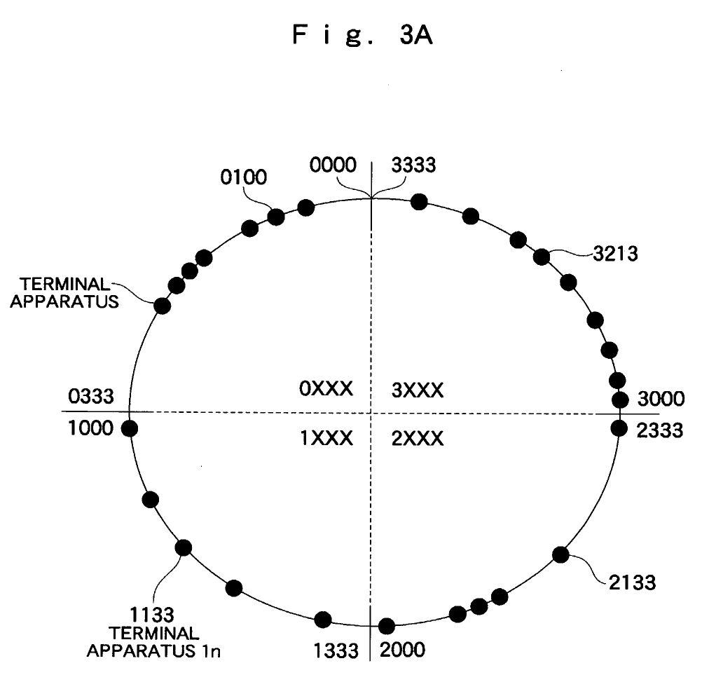

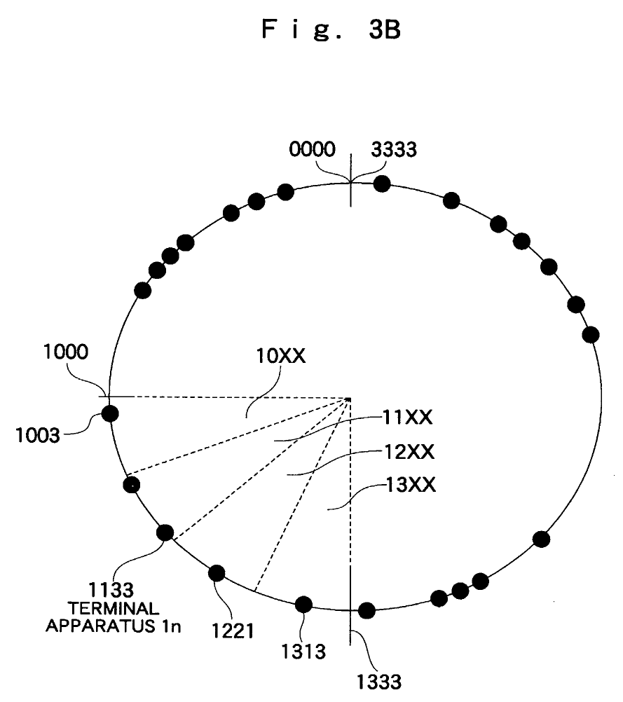

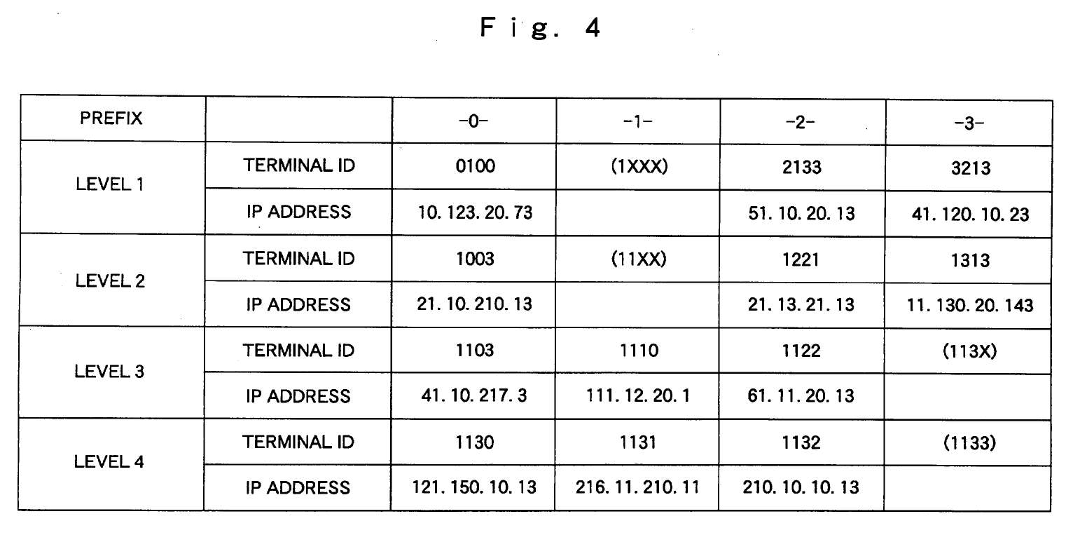

Herein, referring to FIGS. 3A, 3B and 4, a description will be given of a routing table used in the DHT. FIGS. 3A and 3B are diagrams for illustrating the routing table, while FIG. 4 is one example of the routing table. The routing table is held by each terminal apparatus 1 in order to access another terminal apparatus 1 from the terminal apparatus 1, and it is formed when each terminal apparatus 1 participates in the information distribution system S, and the like.

The routing table, in accordance with predetermined rules, divides the terminal apparatus 1 included in the information distribution system S into a plurality of groups, takes each of these groups to be a level one group, further divides a group, among the level one groups, to which its own apparatus belongs into a plurality of groups, takes each of these groups to be a level two group, makes groups up to level n by means of the same kind of group division as the level two group division, and stores location information (an IP address) of one terminal apparatus 1 belonging to each group (except a group to which its own terminal apparatus belongs) of each step. n being a positive integer of three or more, it differs depending on an ID space of the terminal ID. For example, as shown below, in a case of an 8-bit wide quaternary number, n=4.

Herein, a description will be given of a routing table held by a terminal apparatus 1n, whose terminal ID is “1133”, in a case in which the terminal ID is expressed as an 8-bit wide quaternary number (“0000” to “3333”).

As shown in FIG. 3A, by dividing the ID space of the terminal ID into four, it is divided into groups of four areas, “0XXX”, “1XXX, “2XXX” and “3XXX” (X is a positive integer between 0 and 3 inclusive, the same applying hereafter), whose first digits differ. These are level one groups. As the terminal ID of the terminal apparatus 1n is “1133”, the terminal apparatus 1n belongs to a level one group which is the area “1XXX” in a bottom left in FIG. 3A. Consequently, as shown in FIG. 4, a terminal ID and an IP address of terminal apparatus 1 existing in groups (that is, each group of the area “0XXX”, the area “2XXX” and the area “3XXX”) other than the level one group in which the terminal apparatus 1n exists, are stored in a level one table of the terminal apparatus 1n routing table. In this table, a terminal ID and an IP address of each of “0100” as a terminal ID of the area “0XXX”, “2133” as a terminal ID of the area “2XXX”, and “3213” as a terminal ID of the area “3XXX” are stored.

Next, as shown in FIG. 3B, of the level one groups, the group to which the terminal apparatus 1n belongs is further divided in four, dividing it into groups of areas “10XX”, “11XX”, “12XX” and “13XX”. These are level two groups. In the case of the terminal apparatus 1n, as the terminal ID of the apparatus 1n itself is “1133”, a terminal ID and an IP address of terminal apparatus 1 belonging to each level two group (that is, each group of the area “10XX”, the area “12XX” and the area “13XX”) other than a level two group (the group of the area “11XX”) to which the terminal apparatus 1n belongs, are stored in a level two table of the terminal apparatus 1n routing table, as shown in FIG. 4. In this table, a terminal ID and an IP address of each of “1003” as a terminal ID of the area “10XX”, “1221” as a terminal ID of the area “12XX”, and “1313” as a terminal ID of the area “13XX” are stored.

Hereafter, in the same way, of the level two groups, the group to which the terminal apparatus 1n belongs is further divided in four, dividing it into groups (level three groups) of areas “110X”, “111X”, “112X” and “113X”, and a terminal ID and an IP address of terminal apparatus 1 belonging to each level three group (that is, each group of the area “110X”, the area “111X” and the area “112X”) other than the level three group “113X” to which the terminal apparatus 1n belongs are stored. Also, of the level three groups, the group to which the terminal apparatus 1n belongs is further divided in four, dividing it into groups (level four groups) “1130”, “1131”, “1132” and “1133”, and a terminal ID and an IP address of terminal apparatus 1 belonging to each level four group (that is, each group of “1130”, “1131” and “1132”) other than the level four group “1133” to which the terminal apparatus 1n belongs are stored. In the event that no terminal apparatus 1 exists in the heretofore mentioned groups, terminal ID and IP address columns are empty.

In this way, in the information distribution system S, each terminal apparatus 1 has a routing table in which are correlated terminal ID, which is identification information of one portion of terminal apparatus 1 among the plurality of terminal apparatus 1 in the information distribution system S, and IP addresses, which are location information.

3. Contents Information Disclosure Method

A description will be given of a method when, for example, a certain terminal apparatus 1 in the information distribution system S with this kind of configuration discloses new contents information in such a way that it can be searched for by another terminal apparatus 1 in the information distribution system S. This terminal apparatus 1 becomes a contents holding terminal apparatus. Hereafter, a description will be given of a method of specifying a root terminal apparatus which manages (holds) location information of the contents holding terminal apparatus, using the routing table, and causing the root terminal apparatus to hold the location information of the contents holding terminal apparatus.

A terminal apparatus 1 which becomes a contents holding terminal apparatus transmits a message (hereafter called a “registration message”) requesting a registration of an IP address or the like, which is location information of the apparatus itself (as the contents holding terminal apparatus holding the contents information), toward a terminal apparatus 1 which has the same terminal ID as the contents ID of the contents information held (it is not known at this point whether or not this terminal apparatus 1 actually exists).

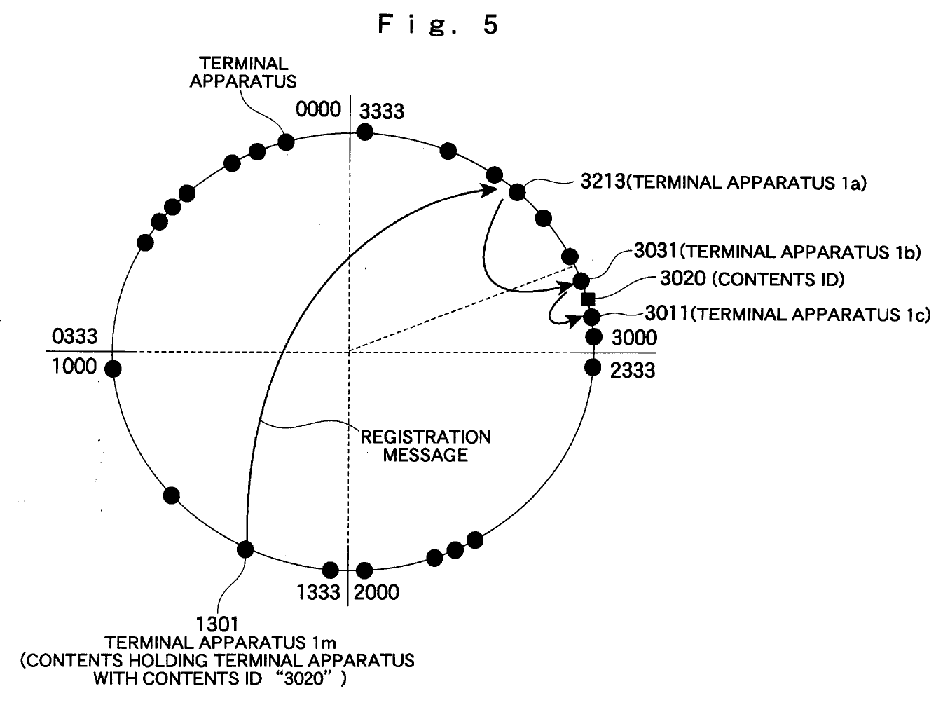

Specifically, as shown in FIG. 5, for example, when a terminal apparatus 1m becomes a contents holding terminal apparatus of the contents ID “3020”, the terminal apparatus 1m generates a registration message with the contents ID “3020” as destination identification information, and transmits the registration message referring to a routing table which is held by itself. Assuming that the terminal apparatus 1m is holding the same kind of routing table as the level one table of the routing table shown in FIG. 4, as the contents ID “3020” is in the area “3XXX”, the terminal apparatus 1m transmits the registration message to a terminal apparatus 1a (terminal ID “3213”), among the terminal apparatus 1 belonging to the area “3XXX”, whose IP address is known to the terminal apparatus 1m (that is, of which the IP address is stored in the routing table which is held by itself). The registration message includes the contents ID of the contents information which is held by the terminal apparatus 1m as the contents holding terminal apparatus, and the contents ID is used as the destination identification information in the registration message.

Next, the terminal apparatus 1a which receives the registration message determines whether or not the registration message is a message directed to the terminal apparatus 1a itself. The determination of whether or not it is a message directed to the terminal apparatus 1a itself is carried out based on the destination identification information and the routing table. Specifically, it is determined whether or not the destination identification information is near a terminal ID which is identification information of the terminal apparatus 1a itself. That is, the terminal apparatus 1a determines, from the terminal ID of the terminal apparatus 1 stored in the routing table (values of the table are not shown) which is held by the terminal apparatus 1a itself, whether the terminal apparatus 1 terminal ID nearest to the destination identification information is its own, or that of another terminal apparatus 1.

Then, as the terminal ID of another terminal apparatus 1 is nearer the destination identification information than the terminal ID of the terminal apparatus 1a itself, the terminal apparatus 1a refers to the level two table of the routing table which is held by the terminal apparatus 1a itself, and forwards the registration message to, among terminal apparatus 1 belonging to the area “30XX”, a terminal apparatus 1b (terminal ID “3031”) whose IP address is known to the terminal apparatus 1a.

In this way, the forwarding of the registration message proceeds by a procedure of matching digits of the contents ID in order from a first digit, and when eventually arriving at a terminal apparatus 1c which has a terminal ID near the destination identification information of the registration message, the terminal apparatus 1c itself judges that it should become a root terminal apparatus of that contents information, and stores the contents ID included in the registration message, and the terminal ID, IP address and the like of the contents holding terminal apparatus (hereafter, these will be called “index information”). Then, as will be described hereafter, on receiving a search message from another terminal apparatus 1, the terminal apparatus 1c selects, from among the stored index information, the IP address which is the location information of the contents holding terminal apparatus, and notifies the terminal apparatus 1 which has transmitted the search message. The forwarding of the message using the routing table in the heretofore described way is called a DHT routing.

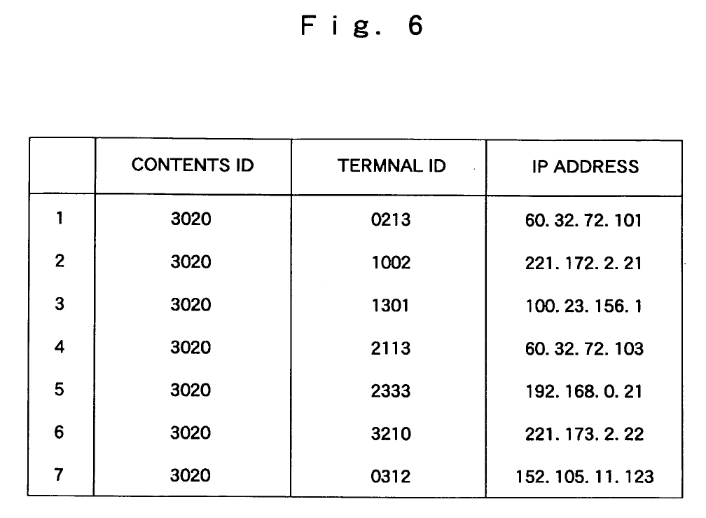

Meanwhile, a holding of the index information in the root terminal apparatus is carried out by the kind of index table shown in FIG. 6. FIG. 6 shows an example of an index table in the root terminal apparatus 1c, and it stores the terminal ID, IP addresses, introduction times (not shown) and the like of the contents holding terminal apparatus holding the contents information with the contents ID “3020”, which is managed by its own terminal apparatus.

4. Contents Information Acquisition Method

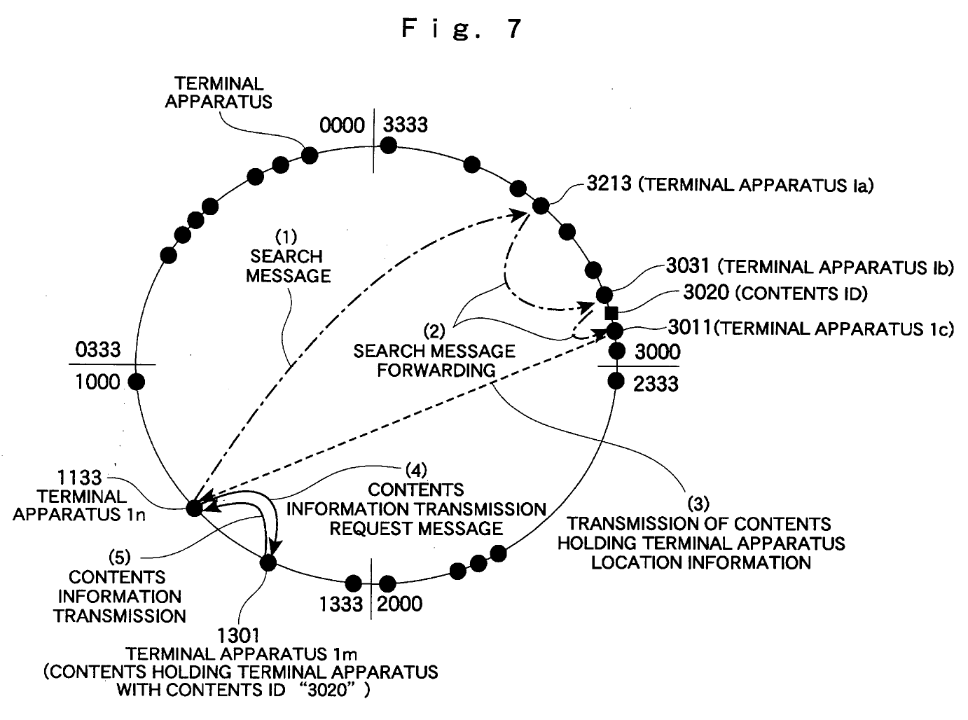

Next, referring to FIG. 7, a description will be given of one example of a method of searching for a terminal apparatus 1 which holds the contents information. FIG. 7 is a diagram showing one example of an aspect of a terminal apparatus 1 which holds the contents information being searched for by DHT.

Herein, a description will be given of a procedure when the terminal apparatus 1n whose terminal ID is “1133”, acting as a request terminal apparatus, searches for the contents information having the contents ID “3020”. The request terminal apparatus, in order to receive a distribution of the contents information having the contents ID “3020”, firstly acquires the location information of the contents holding terminal apparatus from the contents information root terminal apparatus, then acquires the contents information from the contents holding terminal apparatus.

As shown in FIG. 7, the request terminal apparatus 1n, referring to the routing table of the apparatus itself, with the terminal ID of a terminal apparatus 1 having the terminal ID of the same area “3XXX” as the contents ID “3020” as a destination, and the contents ID “3020” as destination identification information, transmits a message (hereafter called a “search message”) requesting a transmission of contents holding terminal apparatus information (information including the IP address which is the location information of the contents holding terminal apparatus) (refer to (1) shown in FIG. 7). Then, the search message too, in the same way as the heretofore described registration message, is continuously forwarded in accordance with the routing table (refer to (2) shown in FIG. 7) and, when eventually arriving at the terminal apparatus 1c (terminal ID “3011”), which is the root terminal apparatus managing the contents information with the contents ID “3020”, the root terminal apparatus 1c searches among the index information stored in the index table which is managed by itself for the contents ID “3020” included in the search message, and returns an IP address, and the like, of a contents holding terminal apparatus (herein, taken to be the terminal apparatus 1m) possessing the contents information with the contents ID “3020” to the request terminal apparatus 1n (refer to (3) shown in FIG. 7). By this means, the request terminal apparatus 1n can acquire the location information of the contents holding terminal apparatus holding the contents information of which it wishes to receive a distribution.

The request terminal apparatus 1n knows the location information of the contents information with the contents ID “3020”, that is, the IP address of the contents holding terminal apparatus 1m holding the contents information with the contents ID “3020”, by receiving it from the root terminal apparatus 1c. The request terminal apparatus 1n acquires the contents information from the contents holding terminal apparatus 1m (refer to (5) in FIG. 7) by transmitting a request for a distribution of the contents information (hereafter called a “contents information transmission request message”) to the contents holding terminal apparatus 1m with the contents ID “3020” (refer to (4) shown in FIG. 7).

Meanwhile, the request terminal apparatus, when acquiring the location information of the contents holding terminal apparatus from the root terminal apparatus, acquires the location information of a plurality of contents holding terminal apparatus. Then, the request terminal apparatus transmits the contents information transmission request message to one contents holding terminal apparatus among the plurality of contents holding terminal apparatus whose location information has been acquired. As long as the request is accepted, the request terminal apparatus acquires the contents from the contents holding terminal apparatus which has accepted the request. Meanwhile, in the event that the request is refused and not accepted, the request terminal apparatus transmits the contents information transmission request message to a next contents holding terminal apparatus among the plurality of contents holding terminal apparatus whose location information has been acquired.

Heretofore, a description has been given of the information distribution system S by means of 1. Configuration etc. of Information Distribution, 2. Routing Table, 3. Contents Information Disclosure Method, and 4. Contents Information Acquisition Method. In this way, the information distribution system S is a system which, being formed by the participation of the plurality of terminal apparatus mutually connected via the network, carries out the transmission and reception of contents information among the terminal apparatus, and the terminal apparatus hold the contents information.

Next, a description will be given of a method of realizing noise reduction and power saving in the terminal apparatus, in the previously described information distribution system S.

5. Configuration of Terminal Apparatus

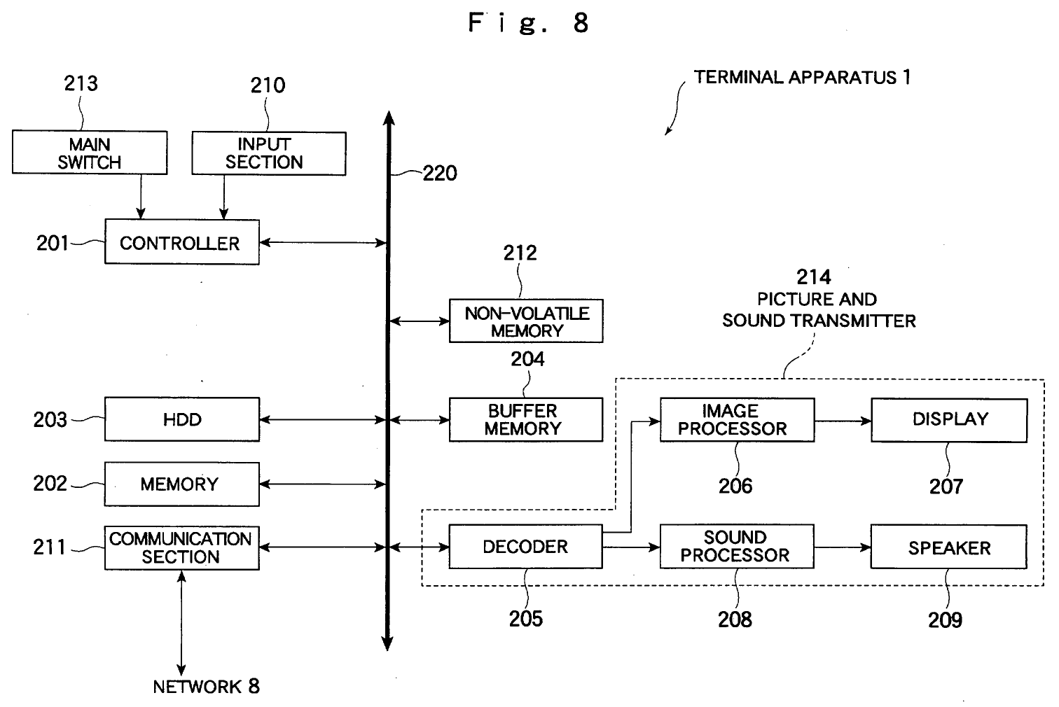

Firstly, a description will be given of a functional configuration of the terminal apparatus 1. FIG. 8 is an outline diagram showing a functional configuration example of the terminal apparatus 1. The terminal apparatus 1, a general personal computer as well as a designated computer being applicable, includes a controller 201, a rewritable memory 202, which stores the routing table, the index table and the like, an HDD 203 (corresponding to one example of a contents information storage section), which stores the contents information, a buffer memory 204, which temporarily stores contents information received from an exterior, a decoder 205, which sequentially retrieves and decodes the contents information stored on the HDD 203 and in the buffer memory 204, an image processor 206, which converts image information, among the contents information decoded by the decoder 205, into information displayable on a display 207, to be described hereafter, the display 207, such as a liquid crystal display (LCD), which displays an image based on an output from the image processor 206, a sound processor 208, which converts sound information, among the contents information decoded by the decoder 205, into information transmissible as a sound wave from a speaker 209, to be described hereafter, the speaker 209, which transmits a sound wave based on an output from the sound processor 208, an input section 210, consisting of a mouse and keyboard or the like, a communication section 211 for communicating with another terminal apparatus 1 via the network 8, a non-volatile memory 212 (corresponding to one example of a contents list storage section), which stores a list (a held contents list which functions as a contents holder of the contents information) of the contents information stored by the HDD 203, and a main switch 213, with which a deactivation operation is carried out by a user at a time of stopping a viewing or listening, and an activation operation is carried out at a time of starting a viewing or listening. The controller 201, the memory 202, the HDD 203, the buffer memory 204, the decoder 205, the communication section 211 and the non-volatile memory 212 are mutually connected via a system bus 220. Also, a picture and sound transmitter 214 is configured of the decoder 205, the image processor 206, the display 207, the sound processor 208 and the speaker 209. The non-volatile memory 212, in addition to storing the held contents list, may also store a predetermined size of leading portion among the contents information (in this case, the non-volatile memory 212 corresponds to one example of a contents leading portion storage section) In this case, the HDD 203 stores the contents information succeeding the leading portion.

The controller 201 is configured of a CPU (Central Processing Unit), an internal ROM (Read Only Memory), and an internal RAM (Random Access Memory). An information processing program for participating in the information distribution system S, and transmitting and receiving the contents information, is stored in the internal ROM. That is, the information processing program is a program for putting into practice the sections for carrying out the processes and the like shown in the previously described 3. Contents Information Disclosure Method, and 4. Contents Information Acquisition Method, and a stop control section, a contents existence determination section, a drive control section, a contents distribution section, a contents list update section, and a contents storage control section, all to be described hereafter. For example, a flash memory is used as the internal ROM.

The CPU retrieves the information processing program stored in the internal ROM and, in accordance with the information processing program, carries out a process inputting data input from the input section 210, a processing of a main switch activated condition and deactivated condition input from the main switch 213, a process saving the contents information on the HDD 203, a process retrieving the contents information from the HDD 203, a process updating the routing table, index table and the like of the memory 202, and the like, centrally controlling the input section 210, the main switch 213, the memory 202, the HDD 203, the buffer memory 204, the decoder 205, the communication section 211, and the non-volatile memory 212.

It is acceptable that the information processing program is, for example, downloaded via the communication section 211 into the internal ROM of the controller 201 from a server connected to the network 8, or that, after being recorded on a recording medium such as a CD-ROM, it is loaded into the internal ROM of the controller 201 via an unshown recording medium drive.

6. Terminal Apparatus Processes

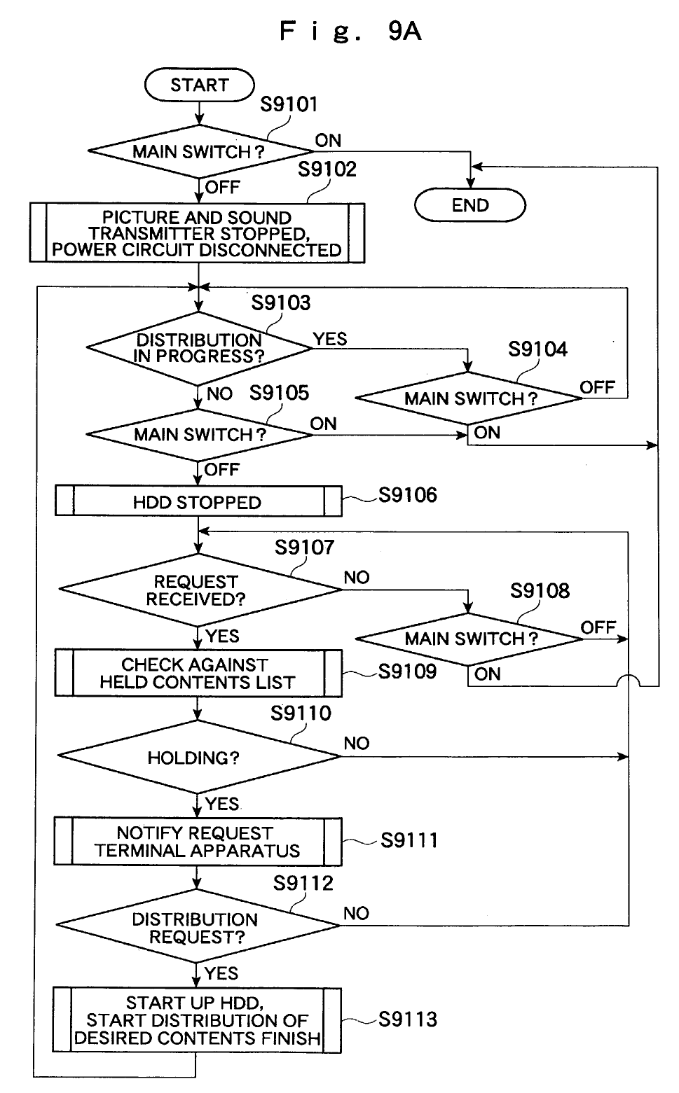

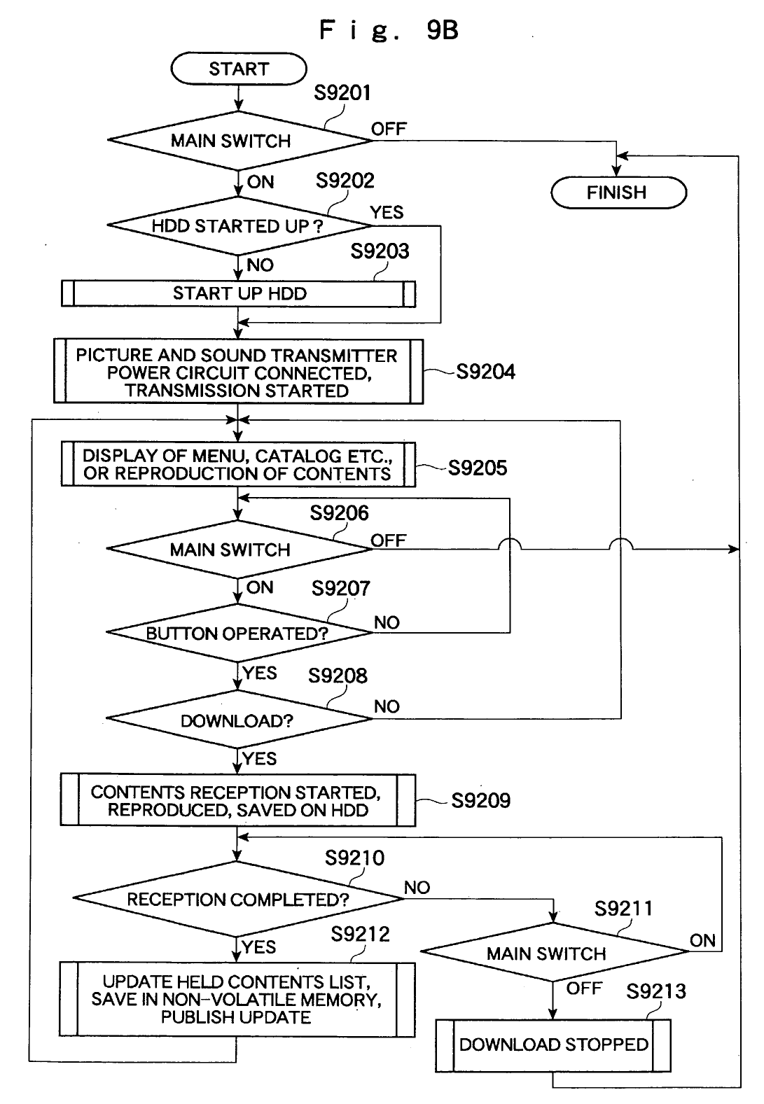

Next, a description will be given of processes for realizing noise reduction and power saving in the terminal apparatus 1. FIGS. 9A and 9B, 10A to 10C, 11A and 11B, and 12 are each diagrams showing one example of a process flow in the terminal apparatus 1.

When a main power switch (not shown) on the terminal apparatus 1 is activated, or when a reset switch (not shown) is operated, the CPU of the controller 201 executes initial setting operations, such as permitting an access to the memory 102, and securing a working area of the internal RAM, and retrieves and executes the information processing program stored in the internal ROM.

Firstly, referring to FIG. 9, a description will be given of a first process. The first process, in a terminal apparatus 1 which is not viewing or listening to the contents information, puts the HDD 203 into a stopped condition when the main switch 213 is in the deactivated condition, and temporarily puts the HDD 203 into a driven condition when the contents information is distributed. It is taken that the held contents list is stored in the non-volatile memory 212, and the contents information is stored on the HDD 203. FIG. 9A shows a process when the main switch is deactivated, which starts when the main switch 213 changes from being activated to being deactivated, and finishes when it changes from being deactivated to being activated, while FIG. 9B shows a process when the main switch is activated, which starts when the main switch 213 changes from being deactivated to being activated, and finishes when it changes from being activated to being deactivated.

With regard to the first process, firstly, a description will be given of the process at the time when the main switch is deactivated. If the controller 201, inputting a condition of the main switch 213, detects that the main switch is deactivated (step S9101: Off), it carries out the process at the time when the main switch is deactivated from step S9102 onward, while if it detects that the main switch is activated (step S9101: On), it finishes the process at the time when the main switch is deactivated. If the controller 201 detects that the main switch is activated, and finishes the process, it shifts to the process at the time when the main switch is activated, to be described hereafter (the same applies to steps S9104 and S9108). If the controller 201 detects that the main switch is deactivated (step S9101: Off), it puts the picture and sound transmitter 214 into a stopped condition (step S9102) By this means, a power circuit of the picture and sound transmitter 214 is cut off, and a picture display operation and sound transmission operation stop. Herein, the stopped condition refers to a condition in which, the power circuit being cut off and a power supply not being carried out, there is no drive (the same applies to the stopped condition of the HDD 203).

The controller 201 determines whether or not the contents information is being distributed (step S9103) and, when the contents information is in the process of being distributed (step S9103: Yes), and the main switch is deactivated (step S9104: Off), it returns the process to step S9103. Also, when the contents information is in the process of being distributed (step S9103: Yes), and the main switch is activated (step S9104: On), or when the contents information is not in the process of being distributed (step S9103: No), and the main switch is activated (step S9105: On), the controller 201 finishes the process at the time when the main switch is deactivated.

Also, when the contents information is not in the process of being distributed (step S9103: No), and the main switch is deactivated (step S9105: Off), the controller 201 puts the HDD 203 into the stopped condition in order to stop an operation of the HDD 203 (step S9106). By this means, when the main switch is deactivated, and the contents information is not being distributed, the HDD 203 attains the stopped condition. In this way, the controller 201 functions as a stop control section which, in the event of receiving an instruction to shift the HDD 203 from the driven condition to the stopped condition, such as, for example, the case in which the main switch 213 shifts from being activated to being deactivated, after finishing the distribution of the contents information, puts the HDD 203 into the stopped condition.

If the controller 201 receives a distribution request indicating a request for the contents information from the request terminal apparatus, via the network 8 and the communication section 211 (step S9107: Yes), it checks it against the held contents list stored in the non-volatile memory 212 (step S9109). Then, the controller 201 determines whether or not it is holding on the HDD 203 the contents information which is the subject of the distribution request and, if it is holding it (step S9110: Yes), notifies the request terminal apparatus which has transmitted the distribution request of the fact that it is holding the desired contents information (step S9111). In this way, the controller 201 functions as a contents existence determination section which, by means of the held contents list, determines whether or not the contents information which is the subject of the distribution request is stored on the HDD 203.

When, in steps S9107 and S9108, it has not received a distribution request indicating a request for the contents information (step S9107: No), and when the main switch is deactivated (step S9108: Off), the controller 201 returns the process to step S9107. Also, when it has not received a distribution request indicating a request for the contents information (step S9107: No), and when the main switch is activated (step S9108: On), the controller 201 finishes the process at the time when the main switch is deactivated. Also, if the controller 201, in step S9110, is not holding on the HDD 203 the contents information which is the subject of the distribution request (step S9110: No), it returns the process to step S9107.

In step S9112, the controller 201, if it receives a distribution request (step S9112: Yes), puts the HDD 203 into the driven condition (step S9113). By this means, the HDD 203 starts up. Herein, the driven condition refers to a time at which the power supply is started in the case in which the power supply to the HDD 203 is stopped, and also refers to a time at which the drive is started in the case in which, although the power is being supplied to the HDD 203, the HDD 203 is stopped. Then, the controller 201 retrieves the contents information which is the subject of the distribution request from the HDD 203, carries out a distribution (step S9113), and returns the process to step S9103. Also, in step S9112, the controller 201, if it does not receive a distribution request (step S9112: No), returns the process to step S9107. In this way, the controller 201 functions as a drive control section which, when the contents information which is the subject of the distribution is stored on the HDD 203, puts the HDD 203 into the driven condition, and also functions as a contents distribution section which, after the HDD 203 has attained the driven condition, retrieves the contents information from the HDD 203, and distributes it.

Next, with regard to the first process, a description will be given of the process at the time when the main switch is activated. If the controller 201, inputting the condition of the main switch 213, detects that the main switch is activated (step S9201: On), it carries out the process at the time when the main switch is activated from step S9202 onward, while if it detects that the main switch is deactivated (step S9201: Off), it finishes the process at the time when the main switch is activated. If the controller 201 detects that the main switch is deactivated, and finishes the process, it executes the previously described process at the time when the main switch is deactivated (the same applies to steps S9206 and S9211). In step S9202, when the HDD 203 is not started up (step S9202: No), the controller 201 puts the HDD 203 into the driven condition (step S9203). By this means, the HDD 203 starts up. Also, when the HDD 203 is started up (step S9202: Yes), the controller 201 shifts the process to step S9204.

The controller 201 puts the picture and sound transmitter 214 into the driven condition (step S9204). By this means, the power circuit of the picture and sound transmitter 214 is connected, and the picture display operation and sound transmission operation start.

The controller 201 carries out a display of a menu, a catalog or the like, or a reproduction of contents, by means of the picture and sound transmitter 214 (step S9205). Then, the controller 201, when the main switch is activated (step S9206: On), and when there is an operation of a button of the input section 210 by the user (step S9207: Yes), determines whether or not there is a download request to receive a distribution of the contents information from another terminal apparatus 1 (step S9208). Also, in step S9206, when the main switch is deactivated (step S9206: Off), the controller 201 finishes the process at the time when the main switch is activated. Also, in steps S9206 and S9207, when the main switch is activated (step S9206: On), and when there is no operation of a button of the input section 210 by the user (step S9207: No), the controller 201 returns the process to step S9206.

When there is a download request (step S9208: Yes), the controller 201, in order to receive the contents information which is the download subject, transmits a search message and a contents information transmission request message in order to acquire the location information of the contents information, and starts a reception of the contents information (step S9209). Furthermore, the controller 201, by means of the picture and sound transmitter 214, starts a reproduction of the contents information received, and saves the contents information on the HDD 203 (step S9209). Also, in step S9208, when there is no download request (step S9208: No), the controller 201 returns the process to step S9205.

The controller 201 determines whether or not the reception of the contents information is completed (step S9210), and when the reception is not completed (step S9210: No), and the main switch is activated (step S9211: On), the controller 201 returns the process to step S9210. Also, when the reception of the contents information is not completed (step S9210: No), and the main switch is deactivated (step S9211: Off), the controller 201 stops the download process (step S9213), and finishes the process at the time when the main switch is activated. Also, if the reception of the contents information is completed (step S9210: Yes), and the saving of the contents information on the HDD 203 is completed, the controller 201 updates the held contents list, saves it in the non-volatile memory 212, and discloses the fact that it holds new contents (transmits a registration message toward a root terminal) (step S9212). Then, the process of the controller 201 returns to step S9205. In this way, the controller 201 functions as a contents list update section which, after the reception of the contents information and their storage on the HDD 203 is completed, updates the held contents list.

In this way, according to the first process, it is arranged in such a way that a terminal apparatus 1 which is not viewing or listening to the contents information puts the HDD 203 into the stopped condition when the main switch 213 is in the deactivated condition and, receiving a distribution request, temporarily puts the HDD 203 into the driven condition when the contents information which is the subject of the distribution request is stored on the HDD 203, and distributes the contents information. By this means, it is possible to hold a time of the driven condition of the HDD 203 to a minimum, and to realize the noise reduction and power saving in the terminal apparatus 1.

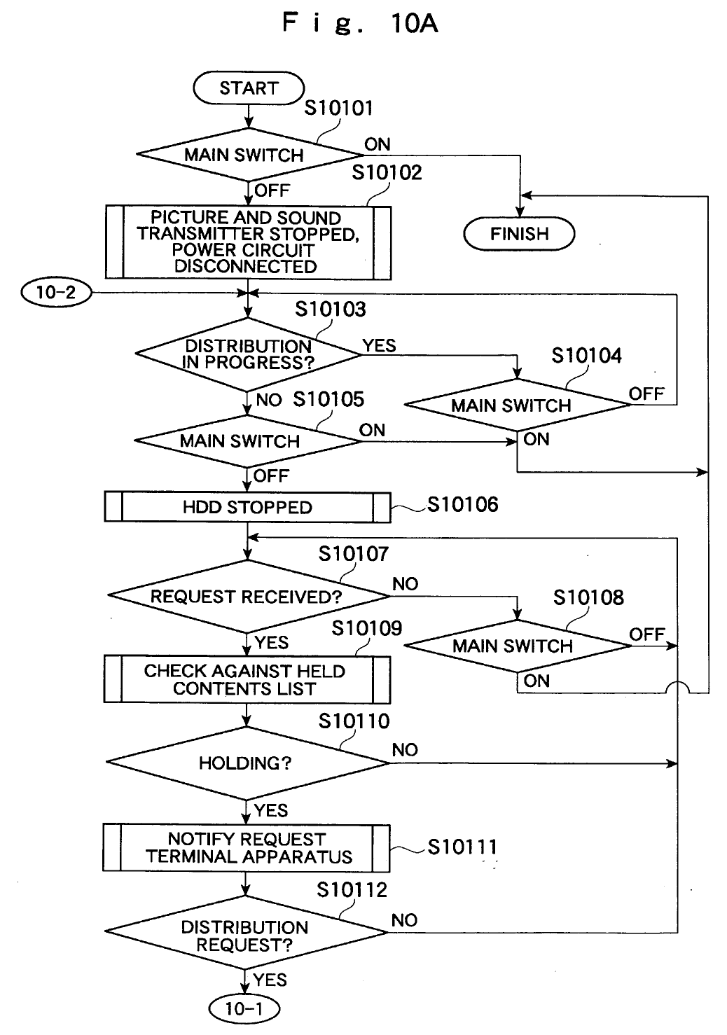

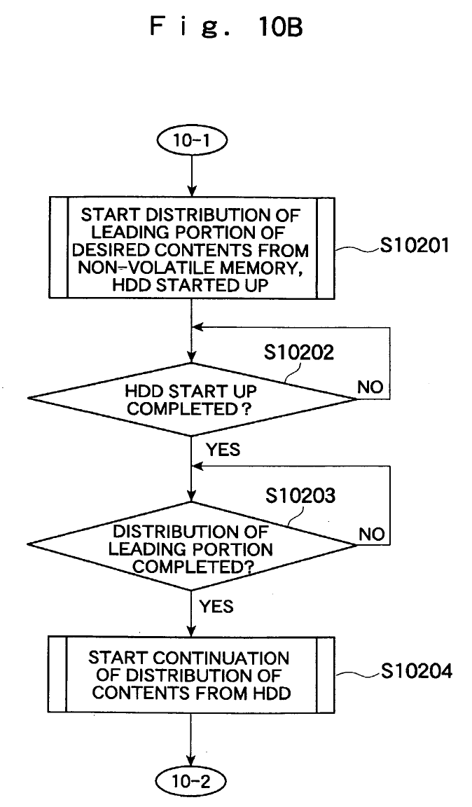

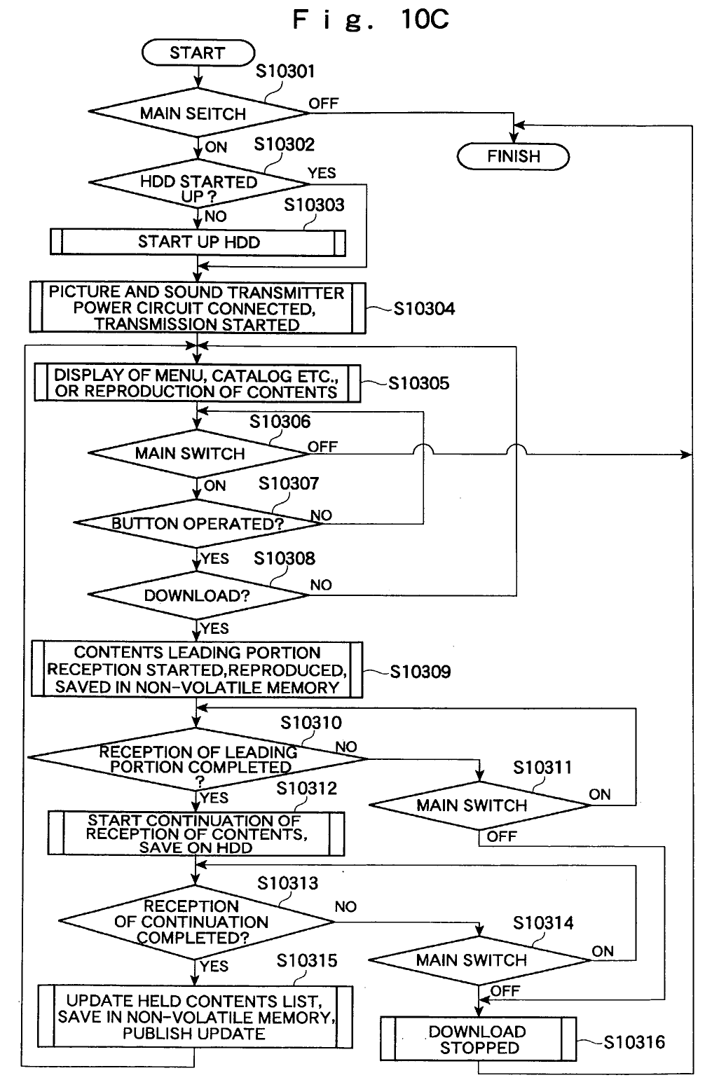

Next, referring to FIGS. 10A to 10C, a description will be given of a second process. The second process, in a terminal apparatus 1 which is not viewing or listening to the contents information, putting the HDD 203 into the stopped condition when the main switch 213 is in the deactivated condition, and temporarily putting the HDD 203 into the driven condition when the contents information is distributed, and also, under a division and management of the contents information, distributing the leading portion of the contents information which is stored in the non-volatile memory 212, and subsequently, carrying out a distribution of the contents information succeeding the leading portion, which is stored on the HDD 203, it stores the leading portion of the contents information received in the non-volatile memory 212, and stores the contents information succeeding the leading portion on the HDD 203. A predetermined size of leading portion of the contents information (for example, a portion whose viewing or listening time is around 30 seconds) is stored in the non-volatile memory 212, and the contents information succeeding the leading portion is stored on the HDD 203. In this case, the controller 201 divides and manages the contents information. FIGS. 10A and 10B show a process when the main switch is deactivated, which starts when the main switch 213 changes from being activated to being deactivated, and finishes when it changes from being deactivated to being activated, while FIG. 10C shows a process when the main switch is activated, which starts when the main switch 213 changes from being deactivated to being activated, and finishes when it changes from being activated to being deactivated.

With regard to the second process, a description will be given of the process at the time when the main switch is deactivated. Herein, as each process of steps S10101 to S10112 is the same as the process of steps S9101 to S9112 in the first process, a description will be omitted.

If the controller 201, after notifying the request terminal apparatus of the fact that it is holding the contents information which is the subject of the distribution request (after step S10111), receives a distribution request (step S10112: Yes), it retrieves, and carries out a distribution of, the leading portion of the contents information which is the subject of the distribution request, which is stored in the non-volatile memory 212, and puts the HDD 203 into the driven condition (step S10201). By this means, the HDD 203 starts up.

The controller 201 determines whether or not the HDD 203 is in the driven condition and the start up completed (step S10202) and, when the start up is completed (step S10202: Yes), it determines whether or not the distribution of the leading portion of the contents information retrieved from the non-volatile memory 212 is completed (step S10203). In step S10202, when the start up of the HDD 203 is not completed (step S10202: No), the controller 201 waits until the start up is completed.

When, in step S10203, the distribution of the leading portion of the contents information retrieved from the non-volatile memory 212 is completed (step S10203: Yes), the controller 201 retrieves the contents information succeeding the leading portion from the HDD 203, and continues the distribution (step S10204). Then, the process of the controller 201 returns to step S10103. In this way, the controller 201 functions as a contents distribution section which retrieves the leading portion of the contents information which is the subject of the distribution request from the non-volatile memory 212, distributes it and, after the HDD 203 attains the driven condition and the distribution of the leading portion is completed, retrieves the contents information succeeding the leading portion from the HDD 203, and continues distributing.

Also, in step S10203, when the distribution of the leading portion of the contents information retrieved from the non-volatile memory 212 is not completed (step S10203: No), the controller 201 waits until the distribution is completed.

Next, with regard to the second process, a description will be given of the process at the time when the main switch is activated. Herein, as each process of steps S10301 to S10308 is the same as the process of steps S9201 to S9208 in the first process, a description will be omitted.

When there is a download request (step S10308: Yes), the controller 201, in order to receive the contents information which is the download subject, transmits a search message and a contents information transmission request message in order to acquire the location information of the contents information, and starts a reception of the contents information (step S10309). In this case, the controller 201, on receiving the predetermined size of leading portion among the contents information, reproduces the leading portion of the contents information received by means of the picture and sound transmitter 214, and saves the leading portion of the contents information in the non-volatile memory 212 (step S10309).

The controller 201 determines whether or not the reception of the leading portion of the contents information is completed (step S10310), and when the reception is not completed (step S10310: No), and the main switch is activated (step S10311: On), the controller 201 returns the process to step S10310. Also, when the reception of the leading portion of the contents information is not completed (step S10310: No), and the main switch is deactivated (step S10311: Off), the controller 201 stops the download process (step S10316), and finishes the process at the time when the main switch is activated. Also, if the reception of the leading portion of the contents information is completed (step S10310: Yes), the controller 201 continues receiving the contents information succeeding the leading portion, and saves the contents information succeeding the leading portion on the HDD 203 (step S10312).

The controller 201 determines whether or not the reception of the contents information succeeding the leading portion is completed (step S10313), and when the reception is not completed (step S10313: No), and the main switch is activated (step S10314: On), the controller 201 returns the process to step S10313. Also, when the reception of the contents information succeeding the leading portion is not completed (step S10313: No), and the main switch is deactivated (step S10314: Off), the controller 201 stops the download process (step S10316), and finishes the process at the time when the main switch is activated. Also, if the reception of the contents information succeeding the leading portion is completed (step S10113: Yes), and the saving of the contents information succeeding the leading portion on the HDD 203 is completed, the controller 201 updates the held contents list, saves it in the non-volatile memory 212, and discloses the fact that it holds new contents (transmits a registration message toward the root terminal) (step S10315). Then, the process of the controller 201 returns to step S10305. In this way, the controller 201 functions as a contents storage control section which stores the predetermined size of leading portion among the contents information received in the non-volatile memory 212, and stores the contents information succeeding the leading portion on the HDD 203.

In this way, according to the second process, it is arranged in such a way that a terminal apparatus 1 which is not viewing or listening to the contents information puts the HDD 203 into the stopped condition when the main switch 213 is in the deactivated condition and, receiving a distribution request, temporarily puts the HDD 203 into the driven condition when the contents information which is the subject of the distribution request is stored on the HDD 203, and distributes the contents information. By this means, it is possible to hold the time of the driven condition of the HDD 203 to a minimum, and to realize the noise reduction and power saving in the terminal apparatus 1. Also, it is arranged in such a way that, by dividing and managing the contents information, the terminal apparatus 1, before the HDD 203 attains the driven condition, retrieves the leading portion of the contents information from the non-volatile memory 212, distributes it and, after the HDD 203 has attained the driven condition and the distribution of the leading portion of the contents information is completed, retrieves the contents information succeeding the leading portion from the HDD 203, and continues the distribution. By this means, as there is no need for the terminal apparatus 1 to wait until the HDD 203 attains the driven condition when distributing the contents information, it does not happen that the distribution is delayed.

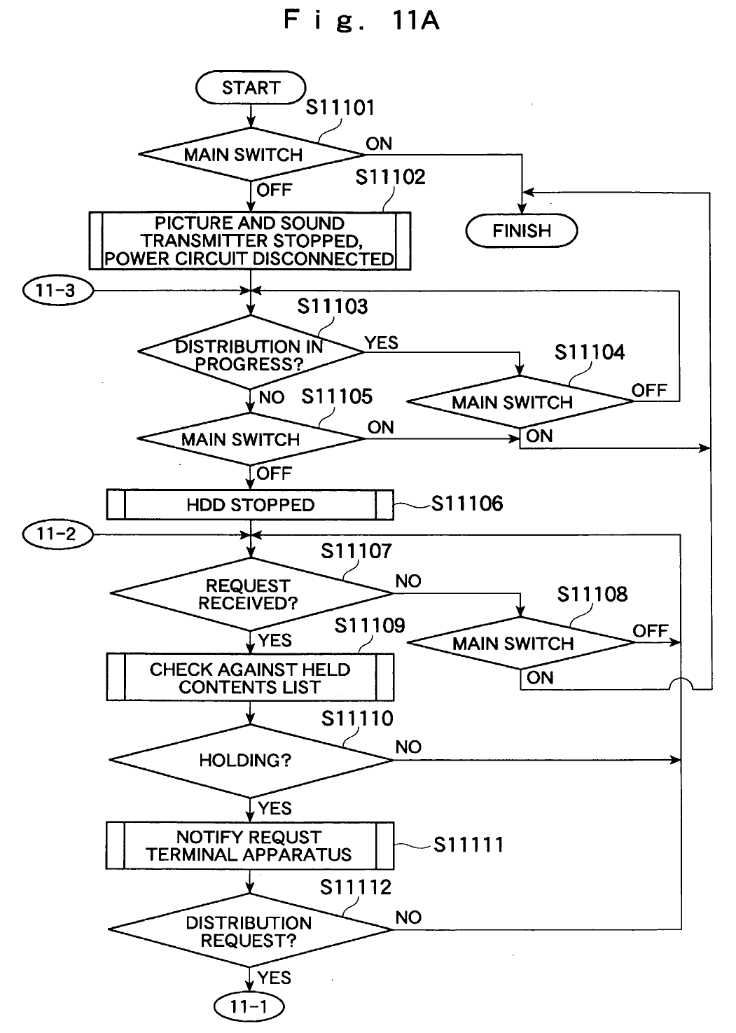

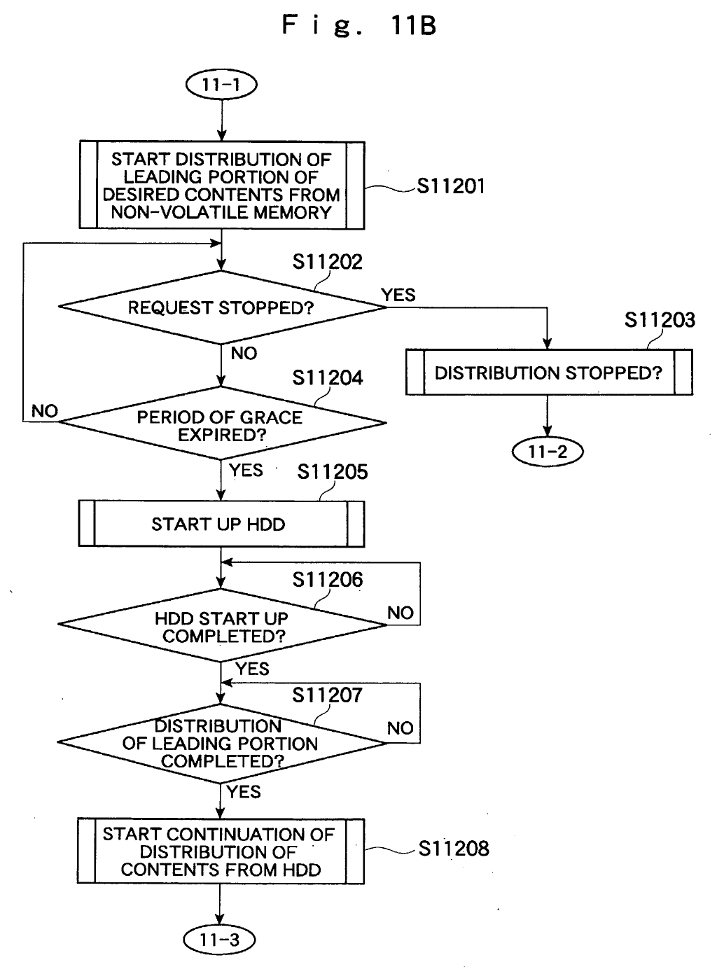

Next, referring to FIGS. 11A and 11B, a description will be given of a third process. The third process, in a terminal apparatus 1 which is not viewing or listening to the contents information, puts the HDD 203 into the stopped condition when the main switch 213 is in the deactivated condition and, when distributing the contents information, distributes the leading portion of the contents information stored in the non-volatile memory 212 and, when a predetermined period of grace from the distribution starting has expired, temporarily puts the HDD 203 into the driven condition. Also, under a division and management of the contents information, it distributes the leading portion of the contents information stored in the non-volatile memory 212, and subsequently, carrying out a distribution of the contents information succeeding the leading portion, which is stored on the HDD 203, it stores the leading portion of the contents information received in the non-volatile memory 212, and stores the contents information succeeding the leading portion on the HDD 203. A predetermined size of leading portion of the contents information is stored in the non-volatile memory 212, and the contents information succeeding the leading portion is stored on the HDD 203. In this case, the controller 201 divides and manages the contents information. FIGS. 11A and 11B show a process at the time when the main switch is deactivated, which starts when the main switch 213 changes from being activated to being deactivated, and finishes when it changes from being deactivated to being activated.

With regard to the third process, a description will be given of the process at the time when the main switch is deactivated. Herein, as each process of steps S11101 to S11112 is the same as the process of steps S10101 to S10112 in the second process, a description will be omitted.

The controller 201, if it receives a distribution request (step S11112: Yes), retrieves, and carries out a distribution of, the leading portion of the contents information which is the subject of the distribution request, which is stored in the non-volatile memory 212 (step S11201).

Herein, it is taken that, in the request terminal apparatus, for example, the user carries out a zapping, and attempts to view or listen to other contents from the request terminal apparatus. In this case, the request terminal apparatus, after transmitting a message to the contents holding terminal apparatus stopping the request, issues a request to another contents holding terminal apparatus for a distribution of new contents. The controller 201, if it receives a message stopping the request from the request terminal apparatus (step S11202: Yes), stops the distribution of the leading portion of the contents information (step S11203). Then, the process of the controller 201 returns to step S11107.

When, in step S11202, the controller 201 does not receive a request stop (step S11202: No), it determines whether or not the predetermined period of grace has expired (step S11204). When the predetermined period of grace has not expired (step S11204: No), the controller 201 returns the process to step S11202. Also, when the predetermined period of grace has expired (step S11204: Yes), the controller 201 puts the HDD 203 into the driven condition (step S10201). In this way, the controller 201 functions as a drive control section which, in the case of receiving a distribution request, puts the HDD 203 into the driven condition after the predetermined period of grace has elapsed. In other words, the HDD 203 maintains the stopped condition in the event that a zapping operation or the like is carried out in the request terminal apparatus within the predetermined period of grace, and the HDD 203 only attains the driven condition in the event that no zapping operation or the like is carried out.

The controller 201 determines whether or not the HDD 203 is in the driven condition and the start up completed (step S11206) and, when the start up is completed (step S11206: Yes), it determines whether or not the distribution of the leading portion of the contents information retrieved from the non-volatile memory 212 is completed (step S11207). In step S11206, when the start up of the HDD 203 is not completed (step S11206: No), the controller 201 waits until the start up is completed.

When, in step S11207, the distribution of the leading portion of the contents information retrieved from the non-volatile memory 212 is completed (step S11207: Yes), the controller 201 retrieves the contents information succeeding the leading portion from the HDD 203, and continues the distribution (step S11208). Then, the process of the controller 201 returns to step S11103. In this way, the controller 201 functions as the contents distribution section which retrieves the leading portion of the contents information which is the subject of the distribution request from the non-volatile memory 212, distributes it and, after the HDD 203 attains the driven condition and the distribution of the leading portion is completed, retrieves the contents information succeeding the leading portion from the HDD 203, and continues distributing.

Also, in step S11207, when the distribution of the leading portion of the contents information retrieved from the non-volatile memory 212 is not completed (step S11207: No), the controller 201 waits until the distribution is completed.

Next, with regard to the third process, as the process at the time when the main switch is activated is the same as the process of steps S10301 to S10316 in the second process shown in FIG. 10C, a description will be omitted here.

In this way, according to the third process, it is arranged in such a way that a terminal apparatus 1 which is not viewing or listening to the contents information puts the HDD 203 into the stopped condition when the main switch 213 is in the deactivated condition and, receiving a distribution request, temporarily puts the HDD 203 into the driven condition when the contents information which is the subject of the distribution request is stored on the HDD 203, and distributes the contents information. By this means, it is possible to hold the time of the driven condition of the HDD 203 to a minimum, and to realize the noise reduction and power saving in the terminal apparatus 1. Also, as it is arranged in such a way that the terminal apparatus 1 puts the HDD 203 into the driven condition after the predetermined period of grace from receiving the distribution request expires, in the event that the distribution stops after a short time due to the zapping, it is sufficient not to put the HDD 203 into the driven condition. By this means, it is possible to further realize the noise reduction and power saving in the terminal apparatus 1.

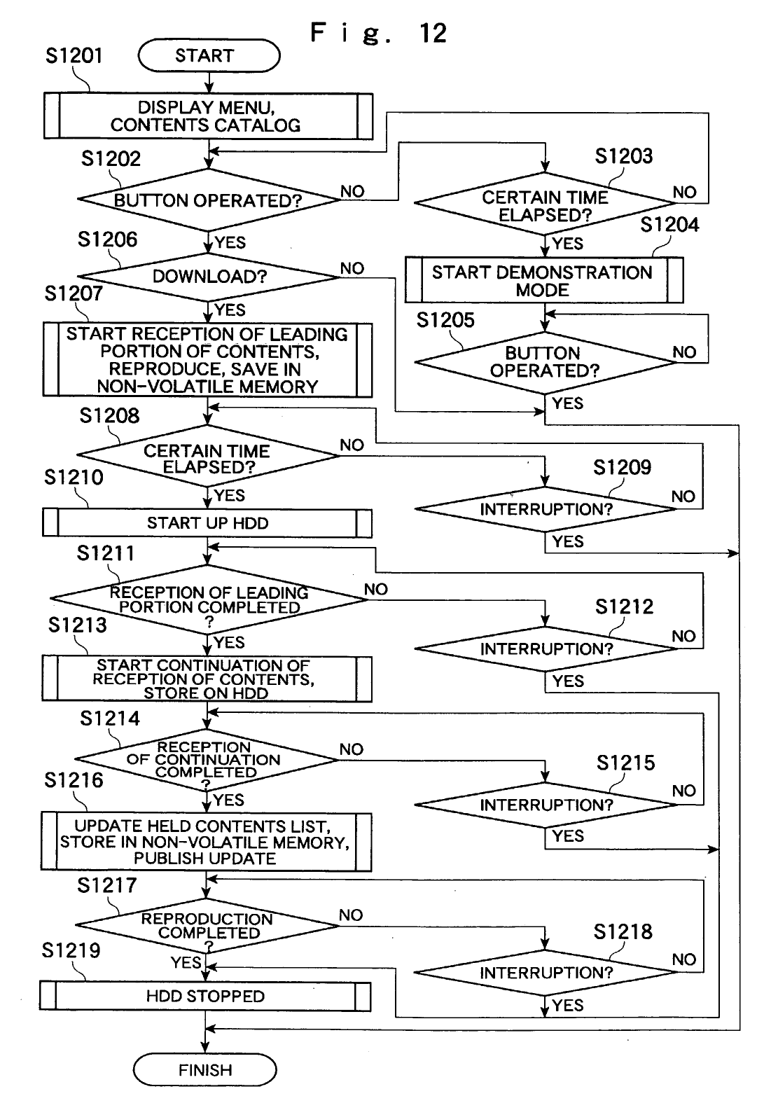

Next, referring to FIG. 12, a description will be given of a fourth process. The fourth process, in a terminal apparatus 1, normally puts the HDD 203 into the stopped condition in a case of viewing or listening to the contents information, and puts the HDD 203 into the driven condition when receiving the contents information, and also, under a division and management of the contents information, stores the leading portion of the contents information received in the non-volatile memory 212, reproduces it, puts the HDD 203 into the driven condition after a certain time elapses from the reception starting, and stores the contents information succeeding the leading portion in the HDD 203 after the reception of the leading portion is completed. Then, when the storage and reproduction of the contents information is completed, it puts the HDD 203 into the stopped condition. A predetermined size of leading portion of the contents information is stored in the non-volatile memory 212, and the contents information succeeding the leading portion is stored on the HDD 203. In this case, the controller 201 divides and manages the contents information.

The controller 201 carries out a display of a menu, a catalog or the like by means of the picture and sound transmitter 214 (step S1201). Then, the controller 201, when there is an operation of a button of the input section 210 by the user (step S1202: Yes), determines whether or not there is a download request (step S1206). Also, in step S1202, when there is no operation of a button of the input section 210 by the user (step S1202: No), the controller 201 determines whether or not a predetermined time has elapsed (step S1203).

In step S1203, when the predetermined time has not elapsed (step S1203: No), the controller 201 returns the process to step S1202, while when the predetermined time has elapsed (step S1203: Yes), the controller 201 starts a demonstration mode (step S1204). Specifically, the controller 201 carries out, for each item of contents information, a retrieval of the leading portion of the contents information from the non-volatile memory 212, and sequentially reproduces the retrieved leading portion of the contents information by means of the picture and sound transmitter 214. Then, when there is an operation of a button of the input section 210 by the user (step S1205: Yes), the controller 201 finishes the fourth process. Also, when there is no operation of a button of the input section 210 by the user (step S1205: No), the controller 201 waits until there is an operation of a button.

In step S1206, when there is a download request (step S1206: Yes), the controller 201, in order to receive the contents information which is the download subject, transmits a search message and a contents information transmission request message in order to acquire the location information of the contents information, and starts a reception of the contents information (step S1207). Furthermore, the controller 201, by means of the picture and sound transmitter 214, starts a reproduction of the contents information received, and saves the predetermined size of leading portion of the contents information in the non-volatile memory 212 (step S1207). Also, in step S1206, when there is no download request (step S1206: No), the controller 201 finishes the fourth process.

The controller 201 determines whether or not the predetermined time has elapsed (step S1208) and, when the predetermined time has not elapsed (step S1208: No), and the reception of the contents information has not been interrupted (step S1209: No), the controller 201 returns the process to step S1208. Also, when the predetermined time has not elapsed (step S1208: No), and the reception of the contents information has been interrupted (step S1209: Yes), the controller 201 finishes the fourth process.

Also, in step S1208, when the predetermined time has elapsed (step S1208: Yes), the controller 201 puts the HDD 203 into the driven condition (step S1210). Then, the controller 201 determines whether or not the reception of the leading portion of the contents information is completed (step S1211) and, when the reception is not completed (step S1211: No), and the reception of the contents information has not been interrupted (step S1212: No), the controller 201 returns the process to step S1211. Also, when the reception of the leading portion of the contents information is not completed (step S1211: No), and the reception of the contents information has been interrupted (step S1212: Yes), the controller 201 shifts the process to step S1219, puts the HDD 203 into the stopped condition (step S1219), and finishes the fourth process. In this way, the controller 201 functions as a drive control section which, in the case of receiving the contents information, puts the HDD 203 into the driven condition after the predetermined time elapses from the reception starting.

If, in step S1211, the reception of the leading portion of the contents information is completed (step S1211: Yes), the controller 201, after the HDD 203 has attained the driven condition, continues receiving the contents information succeeding the leading portion, and saves the contents information succeeding the leading portion on the HDD 203 (step S1213). In this way, the controller 201 functions as the contents storage control section which stores the predetermined size of leading portion among the contents information received in the non-volatile memory 212, and stores the contents information succeeding the leading portion on the HDD 203.

The controller 201 determines whether or not the reception of the contents information succeeding the leading portion is completed (step S1214) and, when the reception is not completed (step S1214: No), and the reception of the contents information has not been interrupted (step S1215: No), the controller 201 returns the process to step S1214. Also, when the reception of the contents information succeeding the leading portion is not completed (step S1214: No), and the reception of the contents information has been interrupted (step S1215: Yes), the controller 201 shifts the process to step S1219, puts the HDD 203 into the stopped condition (step S1219), and finishes the fourth process.

In step S1214, if the reception of the contents information succeeding the leading portion is completed (step S1214: Yes), and the saving of the contents information succeeding the leading portion on the HDD 203 is completed, the controller 201 updates the held contents list, saves it in the non-volatile memory 212, and discloses the fact that it holds new contents (transmits a registration message toward the root terminal) (step S1216). In this way, the controller 201 functions as a contents list update section which, after the reception of the contents information and their storage in the non-volatile memory 212 and on the HDD 203 is completed, updates the held contents list.

The controller 201 determines whether or not the reproduction of the contents information by means of the picture and sound transmitter 214 is completed (step S1217) and, when the reproduction is not completed (step S1217: No), and the reception of the contents information has not been interrupted (step S1218: No), the controller 201 returns the process to step S1217. Also, when the reproduction is not completed (step S1217: No), and the reception of the contents information has been interrupted (step S1218: Yes), the controller 201 shifts the process to step S1219, puts the HDD 203 into the stopped condition (step S1219), and finishes the fourth process.

If, in step S1217, the reproduction of the contents information is completed (step S1217: Yes), the controller 201 puts the HDD 203 into the stopped condition (step S1219), and finishes the fourth process.

In this way, according to the fourth process, it is arranged in such a way that a terminal apparatus 1, in the case of viewing or listening to the contents information, puts the HDD 203 into the stopped condition when not using the HDD 203, and puts the HDD 203 into the driven condition when receiving the contents information. By this means, it is possible to hold the time of the driven condition of the HDD 203 to a minimum, and to realize the noise reduction and power saving in the terminal apparatus 1. Also, as it is arranged in such a way that the terminal apparatus 1 puts the HDD 203 into the driven condition after the predetermined time elapses from starting the reception of the contents information, in the event that the distribution is interrupted after a short time due to the zapping, it is sufficient not to put the HDD 203 into the driven condition. By this means, it is possible to further realize the noise reduction and power saving in the terminal apparatus 1.

Heretofore, a detailed description has been given, based on a number of drawings, of the embodiment of the invention but, this is an illustration, and it is possible to implement the invention in other embodiments incorporating various modifications and improvements based on knowledge of those skilled in the art.

Although the embodiment and modification of the present invention have been described in detail herein, the scope of the invention is not limited thereto. It will be appreciated by those skilled in the art that various modifications may be made without departing from the scope of the invention. Accordingly, the embodiment and modification disclosed herein are only exemplary. It is to be understood that the scope of the invention is not to be limited thereby, but is to be determined by the claims which follow.

What is claimed is:

1. A terminal apparatus in an information distribution system which, being formed by a participation of a plurality of terminal apparatus mutually connected via a network, carries out a transmission and reception of contents information among the terminal apparatus, the terminal apparatus comprising:
a contents information storage section which stores the contents information;
a contents list storage section which stores a list of the contents information stored in the contents information storage section; and
a controller which controls the contents information storage section and the contents list storage section, the controller including:
a stop control section which puts the contents information storage section into a stopped condition;
a contents existence determination section which, in a case of receiving a request for a distribution of contents information from another terminal apparatus, by means of a contents list stored in the contents list storage section, determines whether or not the contents information which is the subject of the distribution request is stored in the contents information storage section;
a drive control section which, in a case in which it is determined, by the contents existence determination section, that the contents information which is the subject of the distribution request is stored in the contents information storage section, puts the contents information storage section into a driven condition; and
a contents distribution section which, after the contents information storage section has attained the driven condition due to the drive control section, retrieves the contents information which is the subject of the distribution request from the contents information storage section, and distributes it.

2. The terminal apparatus according to claim 1, wherein
the stop control section of the controller, in a case of receiving an instruction for the contents information storage section to shift from the driven condition to the stopped condition, when distributing the contents information, puts the contents information storage section into the stopped condition after the distribution of the contents information is completed.

3. The terminal apparatus according to claim 1, wherein the controller further includes:
a contents list update section which, after a reception of contents information from another terminal apparatus and its storage in the contents information storage section is completed, updates the list stored in the contents list storage section.

4. The terminal apparatus according to claim 1, further comprising:
a contents leading portion storage section which stores a predetermined size of leading portion among the contents information, wherein
the contents distribution section of the controller retrieves the leading portion of the contents information which is the subject of the distribution request from the contents leading portion storage section, distributes it and, after the contents information storage section attains the driven condition, and the distribution of the leading portion is completed, retrieves the contents information which is the subject of the distribution request from the contents information storage section, and continues distributing.

5. The terminal apparatus according to claim 4, wherein the controller further includes:
a contents storage control section which, in a case of receiving contents information from another terminal apparatus, stores the predetermined size of leading portion among the contents information in the contents leading portion storage section, and stores contents information succeeding the leading portion in the contents information storage section.

6. The terminal apparatus according to claim 4, wherein
the drive control section of the controller, in a case of receiving a distribution request from another terminal apparatus, puts the contents information storage section into the driven condition after a predetermined time elapses, and
the contents distribution section of the controller retrieves the leading portion of the contents information which is the subject of the distribution request from the contents leading portion storage section, distributes it and, after the contents information storage section attains the driven condition, and the distribution of the leading portion is completed, retrieves the contents information which is the subject of the distribution request from the contents information storage section, and continues distributing.

7. The terminal apparatus according to claim 1, further comprising:
a contents leading portion storage section which stores a predetermined size of leading portion among the contents information, wherein
the drive control section of the controller, in a case of receiving contents information from another terminal apparatus, puts the contents information storage section into the driven condition after a predetermined time elapses, and the controller further includes:
a contents storage control section which, in a case of receiving a distribution of contents information, stores the predetermined size of leading portion among the contents information in the contents leading portion storage section and, after the contents information storage section attains the driven condition, and the storage of the leading portion is completed, stores contents information succeeding the leading portion in the contents information storage section.

8. A recording medium on which an information processing program, which causes a computer to function as each section of the terminal apparatus according to claim 1, is recorded so as to be readable by the computer.

9. An information processing method in an information distribution system which, being formed by a participation of a plurality of terminal apparatus mutually connected via a network, carries out a transmission and reception of contents information among the terminal apparatus, the terminal apparatus including a contents information storage section which stores the contents information, and a contents list storage section which stores a list of the contents information stored in the contents information storage section, the method comprising the steps of:
putting the contents information storage section into a stopped condition;
determining, in a case of receiving a request for a distribution of contents information from another terminal apparatus, by means of a contents list stored in the contents list storage section, whether or not the contents information which is the subject of the distribution request is stored in the contents information storage section;
putting the contents information storage section into a driven condition in a case in which it is determined that the contents information which is the subject of the distribution request is stored in the contents information storage section; and
after the contents information storage section has attained the driven condition, retrieving the contents information which is the subject of the distribution request from the contents information storage section, and distributing it.
